(19) United States
(12) Patent Application Publication
(10) Pub. No.: US 2019/0196194 A1
(43) Pub. Date: Jun. 27, 2019

(54) HEAD-MOUNTED DISPLAY

(71) Applicant: SHARP KABUSHIKI KAISHA, Osaka (JP)

(72) Inventors: DAVID JAMES MONTGOMERY, Oxford (GB); KA HO TAM, Oxford (GB); SCOTT WELLS, Oxford (GB); NARU USUKURA, Sakai City (JP); TOMOHIRO KIMURA, Sakai City (JP)

(21) Appl. No.: 16/192,701

(22) Filed: Nov. 15, 2018

(30) Foreign Application Priority Data
Dec. 26, 2017 (JP) 2017-250225

(51) Int. Cl. G02B 27/01; G02B 5/30; G02F 1/13363; G02B 3/08; G02B 25/00

(52) U.S. Cl. CPC G02B 27/0172; G02B 5/3083; G02F 1/13363; G02B 2027/0123; G02B 25/001; G02F 2001/133638; G02B 3/08

(57) ABSTRACT

A head-mounted display (1) includes: a liquid crystal display unit (2) including a display surface (7) facing forward, the liquid crystal display unit (2) configured to display an image on the display surface (7); an eyepiece lens (13) disposed at a position lower than the liquid crystal display unit (2); and a mirror unit (4) configured to reflect light based on the image displayed on the display surface (7) and guide the light thus reflected to the eyepiece lens (13).

This Nonprovisional application claims priority under 35 U.S.C. § 119 on Patent Application No. 2017-250225 filed in Japan on Dec. 26, 2017, the entire contents of which is hereby incorporated by reference.

### TECHNICAL FIELD

The present invention relates to a compact wearable display, in particular, a head-mounted display.

### BACKGROUND ART

A method of using a lens array to achieve a lightweight HMD is known as conventional art.

Patent Document 1 discloses a two-beamsplitter approach to project a display to the eye. This approach limits a field of view (FOV, Field Of View) and is for an augmented reality application.

Patent Document 2 teaches a single prism element with freeform surfaces in order to reflect a top down- (or side)-mounted micro-display into the eye.

Patent Document 3 discloses multiple prism surfaces with multiple displays to reflect light from top down mounted displays.

Patent Document 4 teaches a display with a prism that reflects/refracts light of a panel at a specific order.

Patent Document 5 discloses a virtual display apparatus that allows two image panels to be joined together as one image.

### CITATION LIST

### Patent Literature

[Patent Literature 1]

Specification of U.S. Pat. No. 8,508,851 (Aug. 13, 2013)

[Patent Literature 2]

Specification of U.S. Pat. No. 9,244,277 (Jan. 26, 2016)

[Patent Literature 3]

Specification of European Patent Application Publication No. 2565700 (Mar. 6, 2013)

[Patent Literature 4]

Pamphlet of International Publication No. WO 2016/118643 (Jul. 28, 2016)

[Patent Literature 5]

Specification of U.S. Pat. No. 6,008,778 (Dec. 28, 1999)

### SUMMARY OF INVENTION

### Technical Problem

There is a demand for a lightweight head-mounted display with a wide field of view (FOV). In a traditional virtual reality (VR) technology, a display which determines the position of a virtual image is mounted in front of an eyepiece lens. This involves a heavy and bulky headset with a holding mechanism for holding the display and the eyepiece lenses. Such a headset is uncomfortable to wear even for a short time. The size is limited by a basic optical system to achieve a correct magnification and a virtual image distance.

One known method for reducing the size and weight of a head-mounted display includes a polarization reflection approach to the size reduction.

Such an approach, however, suffers from ghost image formation.

Another known method uses multiple small lenses with overlapping images that modify the magnification required.

However, such an arrangement has a lower resolution and impairs visibility of the image overlap.

An aspect of the present invention aims to provide a head-mounted display with improved compactness while holding a display unit and an eyepiece lens.

### Solution to Problem

In order to solve the above problem, a head-mounted display in accordance with an aspect of the present invention includes: a display unit including a display surface and configured to display an image on the display surface; an eyepiece lens, when the display unit is viewed in a direction of a normal to the display surface of the display unit, disposed at a position lower or higher than the display unit without overlapping the display unit; and a mirror unit configured to reflect light based on the image displayed on the display surface and guide the light thus reflected to the eyepiece lens.

### Advantageous Effects of Invention

According to an aspect of the present invention, it is possible to provide a head-mounted display with improved compactness while holding a display unit and an eyepiece lens.

### BRIEF DESCRIPTION OF DRAWINGS

FIG. 1 is a schematic diagram of a head-mounted display in accordance with Comparative Example.

FIG. 2 is a schematic diagram illustrating a field of view (FOV) of a head-mounted display.

FIG. 3 is a schematic diagram of a head-mounted display in accordance with Embodiment 1.

FIG. 4 is a schematic diagram of a head-mounted display in accordance with Embodiment 2.

FIG. 5 is a schematic diagram illustrating the problem of stray light.

(a) of FIG. 6 is a schematic diagram of another head-mounted display in accordance with Embodiment 2, and (b) of FIG. 6 is a schematic diagram of still another head-mounted display in accordance with Embodiment 2.

FIG. 7 is a schematic diagram of a head-mounted display in accordance with Embodiment 3.

FIG. 8 is a schematic diagram of a head-mounted display in accordance with Embodiment 4.

FIG. 9 is a schematic diagram of a head-mounted display in accordance with Embodiment 5.

(a) of FIG. 10 is a schematic diagram of a head-mounted display in accordance with Embodiment 6, and (b) of FIG. 10 is an enlarged view of a part A illustrated in (a) of FIG. 10.

FIG. 11 is a schematic diagram of a head-mounted display in accordance with Embodiment 7.

FIG. 12 is a schematic diagram of another head-mounted display in accordance with Embodiment 7.

FIG. 13 is a schematic diagram of still another head-mounted display in accordance with Embodiment 7.

### DESCRIPTION OF EMBODIMENTS

### Embodiment 11

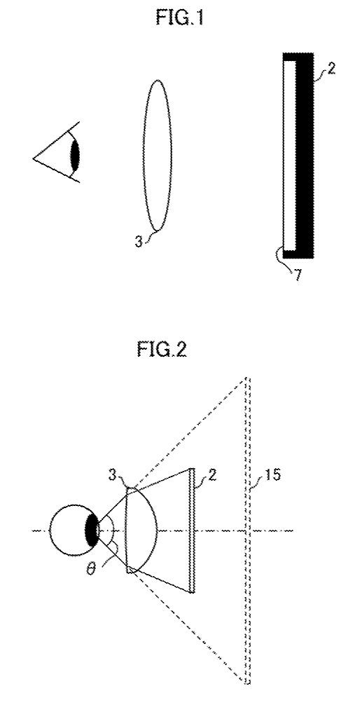

The following will describe an embodiment of the present invention in detail. FIG. 1 is a schematic diagram of a head-mounted display in accordance with Comparative Example. FIG. 1 illustrates the basic layout of a head-mounted display in Comparative Example. The head-mounted display in Comparative Example includes a liquid crystal display unit 2 and an eyepiece lens 3 that projects an image displayed on the liquid crystal display unit 2 onto a far field to enable comfortable viewing. The liquid crystal display unit 2 is positioned in front of the eyepiece lens 3.

FIG. 2 is a schematic diagram illustrating a field of view (FOV) of a head-mounted display. The field of view refers to the range of angles at which a person can view an image. Although the range of angles of a head-mounted display (HMD) changes depending on a rotation angle of eyes, the field of view generally refers to the range of vision of a viewer with the eyes facing the front, i.e., the range of angles from which light enters the eyes. In the example case illustrated in FIG. 2, an angle θ corresponds to a field of view of a head-mounted display. Light based on an image displayed on the liquid crystal display unit 2 is refracted by the eyepiece lens 3 and enters eyes of a head-mounted display wearer. A wider field of view makes larger a virtual image 15 corresponding to an image displayed on the liquid crystal display unit 2 and thus enables comfortable viewing.

To ensure sufficient magnification to have a wide field of view and to have a virtual image at a far enough distance from the eye, compactness of the head-mounted display in this Comparative Example is restricted. In addition, the liquid crystal display unit 2 is a far distance from the eyes.

This means that the liquid crystal display unit 2 must be strapped to the user's head in order not to fall off. Furthermore, the center of gravity of this head-mounted display is far forward of a user. This means that long term viewing causes wear and tear on the user's face and neck.

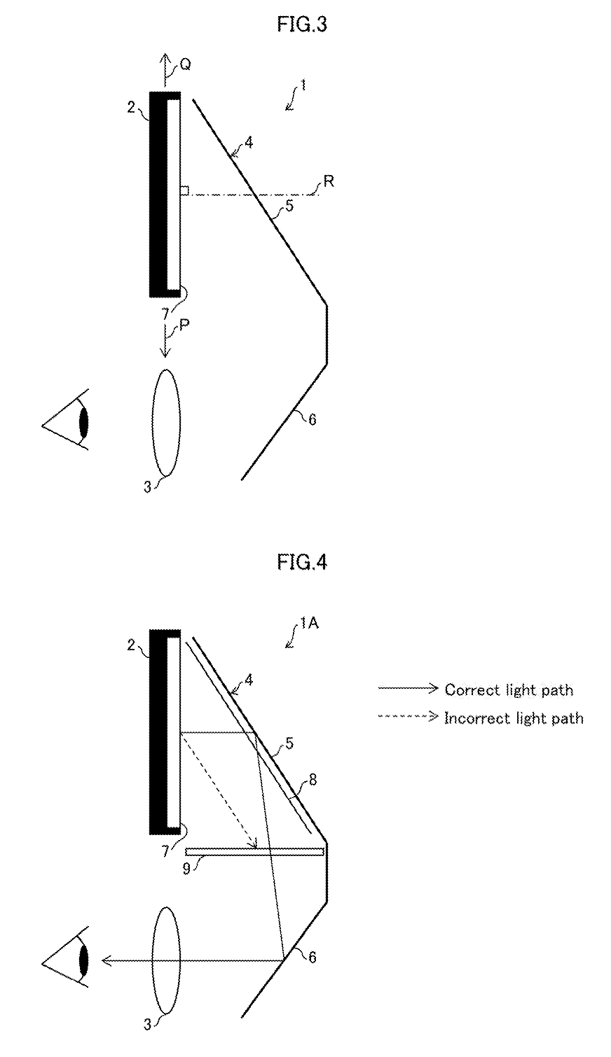

FIG. 3 is a schematic diagram of a head-mounted display 1 in accordance with Embodiment 1. The head-mounted display 1 includes: a liquid crystal display unit 2 (display unit) including a display surface 7 facing forward, the display surface 7 configured to display an image on the display surface 7; an eyepiece lens 3 disposed at a position lower than the liquid crystal display unit 2; and a mirror unit 4 configured to reflect light based on an image displayed on the display surface 7 of the liquid crystal display unit 2 and guide the light thus reflected to the eyepiece lens 3.

Here, “a position lower than the liquid crystal display unit 2” means a position on a side indicated by an arrow P in FIG. 3 relative to the liquid crystal display unit 2, whereas “a position higher than the liquid crystal display unit 2” means a position on a side indicated by an arrow Q in FIG. 3 relative to the liquid crystal display unit 2. In a case where the head-mounted display 1 is worn by the user, the position lower than the liquid crystal display unit 2 generally corresponds to a position on a side toward which gravity acts relative to the liquid crystal display unit 2. The eyepiece lens 3, when the display unit 2 is viewed in a direction corresponding to a normal line R normal to the display surface 7 of the display unit 2, are disposed on the side indicated by the arrow P relative to the display unit 2 without overlapping the display unit 2.

The mirror unit 4 includes: a first mirror 5 configured to reflect light based on an image displayed on the display surface 7; and a second mirror 6 configured to reflect, toward the eyepiece lens 3, light reflected by the first mirror 5. The first mirror 5 and the second mirror 6 are disposed in a V-shaped arrangement. Note that the V-shaped arrangement can be achieved with two mirrors, i.e., the first mirror 5 and the second mirror 6, or can alternatively be achieved with a single integral mirror. The eyepiece lens 3 is disposed in front of the eyes of the user who wears the head-mounted display 1.

The eyepiece lens 3 is provided for projecting thereon an image displayed on the display surface 7 of the display unit 2 based on light reflected by the second mirror 6.

The center of gravity of this head-mounted display 1 is located at a position close to the head of the user. This reduces the torque produced on the head and neck of the user by the wearing of the head-mounted display 1 and makes it less necessary to strap the head-mounted display 1 to the head of the user in order not to fall off.

The two mirrors, i.e., the first mirror 5 and the second mirror 6, are used to reflect light based on an image displayed on the liquid crystal display unit 2. Thus, an image based on light entering the eyepiece lens 3 is not laterally inverted.

Alternatively, the eyepiece lens 3 can be placed at a position higher than the liquid crystal display unit 2.

The eyepiece lens 3 can be a curved lens of known type or a structured Fresnel lens with angled features on known type, or can be a known lens arrangement containing one or more lenses.

### Embodiment 2

The following will describe Embodiment 2 of the present invention. For convenience of description, any members of Embodiment 2 that are identical in function to the members described for Embodiment 1 are assigned the same reference signs, and are not described again here.

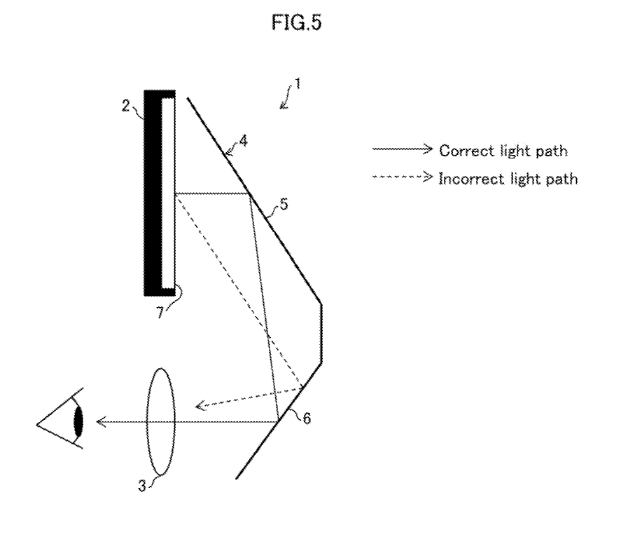

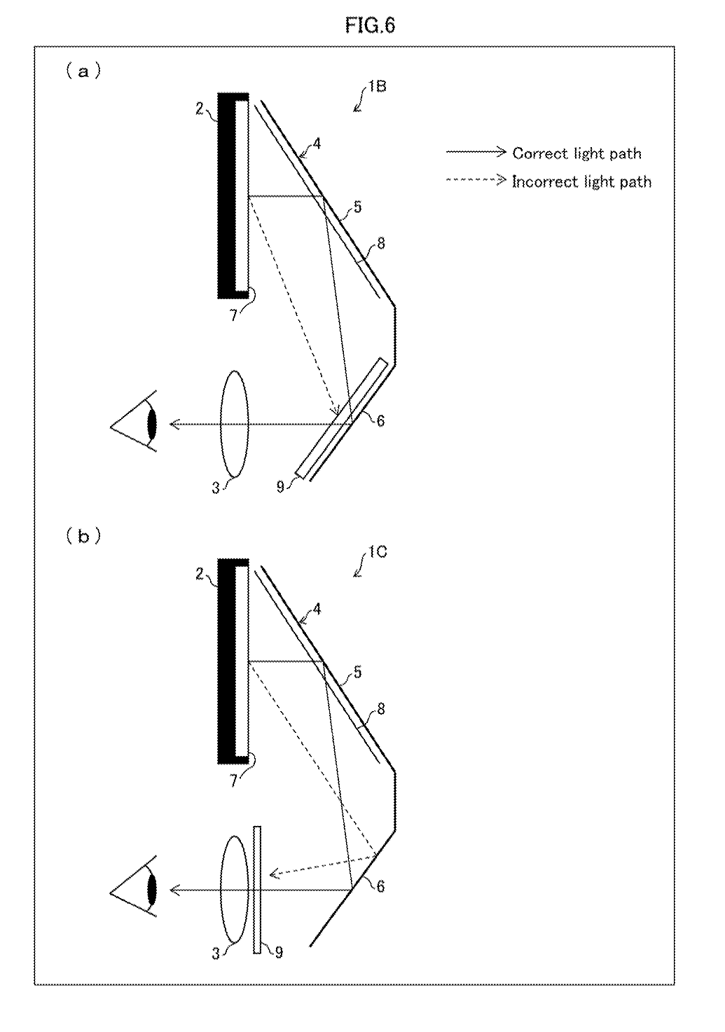

FIG. 4 is a schematic diagram of a head-mounted display 1A in accordance with Embodiment 2. The head-mounted display 1A includes: a quarter wave plate (QWP) 8 disposed on a surface of the first mirror 5; and a polarizing plate 9 configured to transmit light passing through the quarter wave plate 8 and reflected by the first mirror 5, while preventing transmission of direct light from the display surface 7 of the liquid crystal display unit 2.

The quarter wave plate 8 can be constituted by a single layer that can be optimized for off axis performance or can be constituted by two layers (e.g., a half wave plate and a half wave plate).

The polarizing plate 9 is orientated so that it blocks direct light from the liquid crystal display unit 2.

The liquid crystal display unit 2 can be a smartphone.

Eyepiece lenses 3 are provided, one for each eye of the user. The head-mounted display 1A includes two eyepiece lenses 3. A shielding member (not illustrated) for preventing crosstalk is provided between the two eyepiece lenses 3. For example, as the liquid crystal display unit 2, only one smartphone can be provided common to the two eyepiece lenses 3, which are provided one for each eye. Then, two separate images can be displayed on the display surface 7 of the single liquid crystal display unit 2.

FIG. 5 is a schematic diagram illustrating the problem of stray light. The configuration such that the liquid crystal display unit 2 is disposed at a position higher than the eyepiece lenses 3, and the first mirror 5 and the second mirror 6 are provided as illustrated in FIG. 5 can not only cause a light beam from the liquid crystal display unit 2 to be reflected by the first mirror 5 and the second mirror 6 and then enter the eyepiece lenses 3 (light traveling a correct light path indicated by a solid arrow in FIG. 4) but also cause a light beam from the liquid crystal display unit 2 to be directly reflected by the second mirror 6 and then enter the eyepiece lenses 3 (light traveling an incorrect light path indicated by a dashed arrow in FIG. 4).

With the configuration illustrated in FIG. 4 in accordance with Embodiment 2, a direct light beam emitted from the liquid crystal display unit 2 toward the second mirror 6 is blocked by the polarizing plate 9 so as to be prevented from entering the eyepiece lenses 3.

(a) of FIG. 6 is a schematic diagram of another head-mounted display 1B in accordance with Embodiment 2, and (b) of FIG. 6 is a schematic diagram of still another head-mounted display 1C in accordance with Embodiment 2.

The head-mounted display 1A described above with reference to FIG. 4 is configured such that the polarizing plate 9 is disposed between the first mirror 5 and the second mirror 6 so as to be apart from the first mirror 5 and the second mirror 6. However, the present invention is not limited to such a configuration. Alternatively, as in a head-mounted display 1B illustrated in (a) of FIG. 6, the polarizing plate 9 may be disposed on a surface of the second mirror 6.

Further alternatively, as in a head-mounted display 1C illustrated in (b) of FIG. 6, the polarizing plate 9 may be disposed on a surface of the eyepiece lens 3 which surface faces the second mirror 6.

### Embodiment 3

The following will describe Embodiment 3 of the present invention. For convenience of description, any members of Embodiment 3 that are identical in function to the members described for Embodiments 1 and 2 are assigned the same reference signs, and are not described again here.

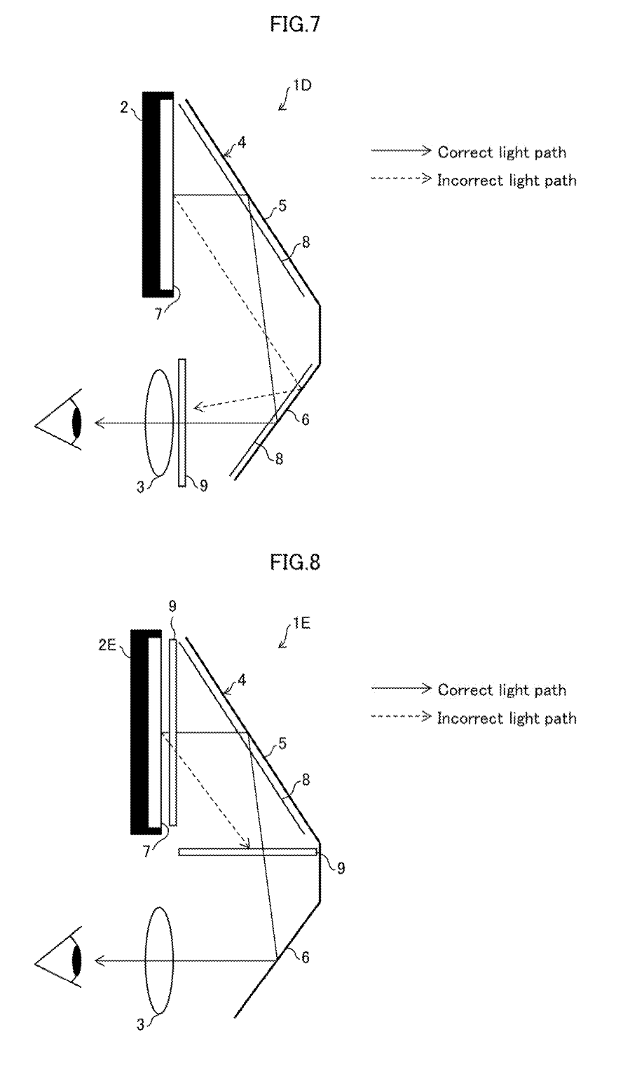

FIG. 7 is a schematic diagram of a head-mounted display 1D in accordance with Embodiment 3. In the head-mounted display 1D, two quarter wave plates 8 (first quarter wave plate and second quarter wave plate) are individually disposed on a surface of the first mirror 5 and on a surface of the second mirror 6. The polarizing plate 9 is disposed on a surface of the eyepiece lens 3 which surface faces the second mirror 6. The polarizing plate 9 is configured to transmit light reflected by the first mirror 5, passing through the quarter wave plate 8 disposed on a surface of the second mirror 6, and then reflected by the second mirror 6, while preventing transmission of light emitted from the display surface 7, directly entering the second mirror 6, and then reflected by the second mirror 6.

The two quarter wave plates 8 disposed in such an arrangement minimize scattering of light from the liquid crystal display unit entering the mirror unit 4 and then reflected by the mirror unit 4 toward the eyepiece lens 3.

### Embodiment 41

The following will describe Embodiment 4 of the present invention. For convenience of description, any members of Embodiment 4 that are identical in function to the members described for Embodiments 1, 2, and 3 are assigned the same reference signs, and are not described again here.

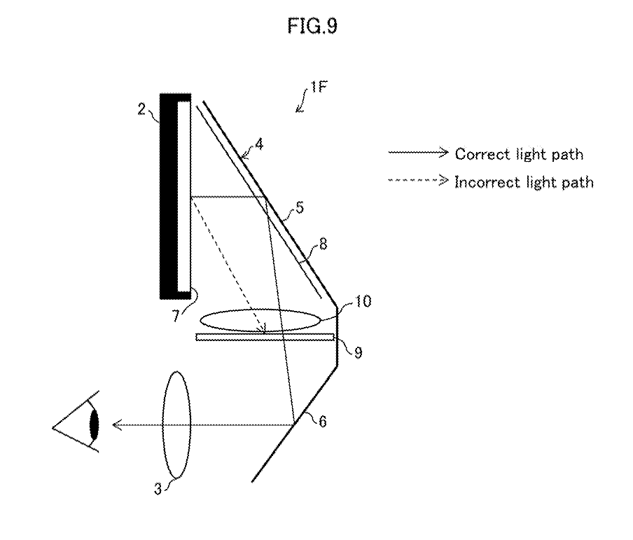

FIG. 8 is a schematic diagram of a head-mounted display 1E in accordance with Embodiment 4. A display unit 2E provided in the head-mounted display 1E is a display unit of any type which is different from the liquid crystal display unit. For example, the display unit 2E is a display unit including an organic light emitting diode (OLED). A first polarizing plate 9 is disposed on the display surface 7 of the display unit 2E. A second polarizing plate 9 is disposed between the first mirror 5 and the second mirror 6.

The second polarizing plate 9 disposed between the first mirror 5 and the second mirror 6 transmits a light beam passing through the quarter wave plate 8 and then reflected by the first mirror 5, while preventing transmission of a light beam emitted from the display surface 7, passing through the first polarizing plate 9 disposed on the display surface 7, and then entering the second polarizing plate 9. That is, direct light from the display surface 7 of the display unit 2E passing through the first polarizing plate 9 toward the second mirror 6 is blocked by the second polarizing plate 9 disposed between the first mirror 5 and the second mirror 6.

### Embodiment 5

The following will describe Embodiment 5 of the present invention. For convenience of description, any members of Embodiment 5 that are identical in function to the members described for Embodiments 1, 2, 3, and 4 are assigned the same reference signs, and are not described again here.

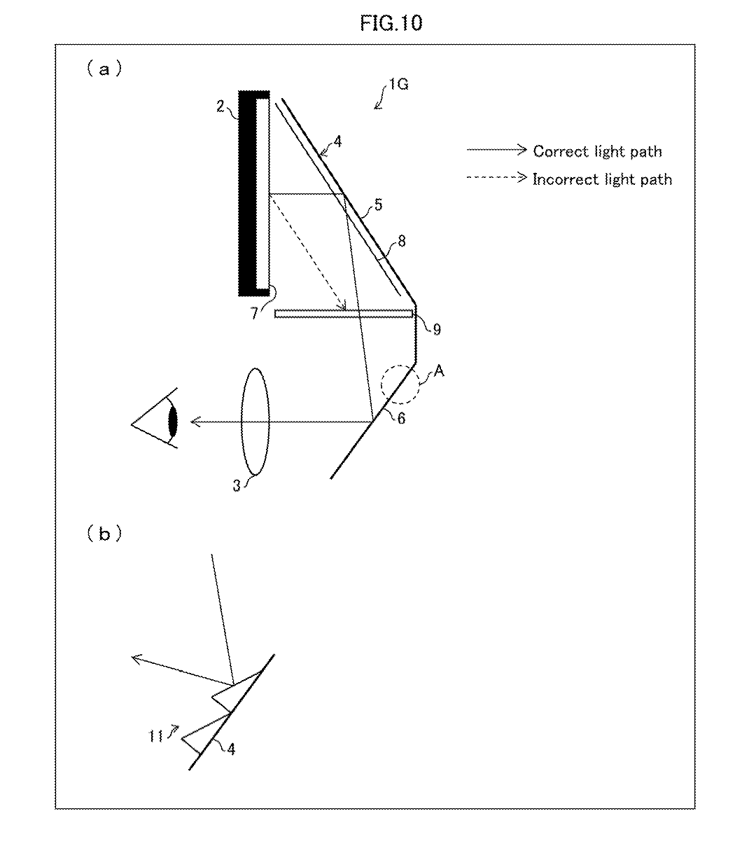

FIG. 9 is a schematic diagram of a head-mounted display 1F in accordance with Embodiment 5. As illustrated in FIG. 9, the head-mounted display 1F is configured such that an aberration lens 10 is provided on the polarizing plate 9 which is disposed between the first mirror 5 and the second mirror 6. The aberration lens 10 can be a curved lens, a lens of a free form structure, or a lens of a Fresnel structure. The aberration lens 10 can be bonded to the polarizing plate 9 or can be provided at a position higher or lower than the polarizing plate 9. Providing the aberration lens 10 as above corrects chromatic aberrations and distortion, minimizes distortion of an image viewed through the eyepiece lens 3, and thus reduces image aberrations.

### Embodiment 61

The following will describe Embodiment 6 of the present invention. For convenience of description, any members of Embodiment 6 that are identical in function to the members described for Embodiments 1, 2, 3, 4, and 5 are assigned the same reference signs, and are not described again here.

(a) of FIG. 10 is a schematic diagram of a head-mounted display 1G in accordance with Embodiment 6, and (b) of FIG. 10 is an enlarged view of a part A illustrated in (a) of FIG. 10. The head-mounted display 1G is configured such that a Fresnel structure 11 is formed on a surface of the second mirror 6. The Fresnel structure 11 has prism elements formed concentrically. Formation of the Fresnel structure 11 allows the head-mounted display 1G to have an improved field of view. Such a wide field of view produces additional distortion. The distortion can be corrected with use of an aberration lens. This causes a corresponding increase in positive power (refractive power) of the eyepiece lens 3.

### Embodiment 71

The following will describe Embodiment 7 of the present invention. For convenience of description, any members of Embodiment 7 that are identical in function to the members described for Embodiments 1, 2, 3, 4, 5, and 6 are assigned the same reference signs, and are not described again here.

FIG. 11 is a schematic diagram of a head-mounted display 1H in accordance with Embodiment 7. The head-mounted display 1H includes a transparent refractive member 12 which transmits light emitted by the display surface 7 of the liquid crystal display unit 2 and reflected by the first mirror 5 and the second mirror 6 toward the eyepiece lens 3. The transparent refractive member 12 includes: a first refracting section 13 which is surrounded by the liquid crystal display unit 2, the quarter wave plate 8, and the polarizing plate 9; and a second refracting section 14 which is surrounded by the polarizing plate 9, the second mirror 6, and the eyepiece lens 3. The transparent refractive member 12 is made from a transparent refractive material such as polymethyl methacrylate (PMMA). The transparent refractive member 12 is higher in refractive index than air.

The use of the transparent refractive member 12 configured as above generally allows a head-mounted display designed with the same field of view to have a light passage region in the transparent refractive member 12 smaller than that in air. This is because a material with a high refractive index has a small angle of refraction. This makes it possible to design a head-mounted display of the same size with a wider field of view.

The first refracting section 13 can be shaped to fit an area surrounded by the liquid crystal display unit 2, the quarter wave plate 8, and the polarizing plate 9. The second refracting section 14 can be shaped to fit an area surrounded by the polarizing plate 9, the second mirror 6, and the eyepiece lens 3.

The first refracting section 13 can be formed such that it is bonded to the liquid crystal display unit 2 or can be formed such that it is separated from the liquid crystal display unit 2. In a case where the liquid crystal display unit 2 is a smartphone attachable and detachable from the head-mounted display 1H, it is unnecessary for the first refracting section 13 to be bonded to the liquid crystal display unit 2.

It is preferable that the quarter wave plate 8 and the polarizing plate 9 be bonded to the transparent refractive member 12, from the viewpoint of reducing ghost images.

Anti-reflection coatings provided on polished surfaces of the transparent refractive member 12 (through which light passes) also reduce ghost images and improve efficiency.

The eyepiece lens 3 may be a curved-surface part of the transparent refractive member 12 or may be a separate member bonded to the transparent refractive member 12.

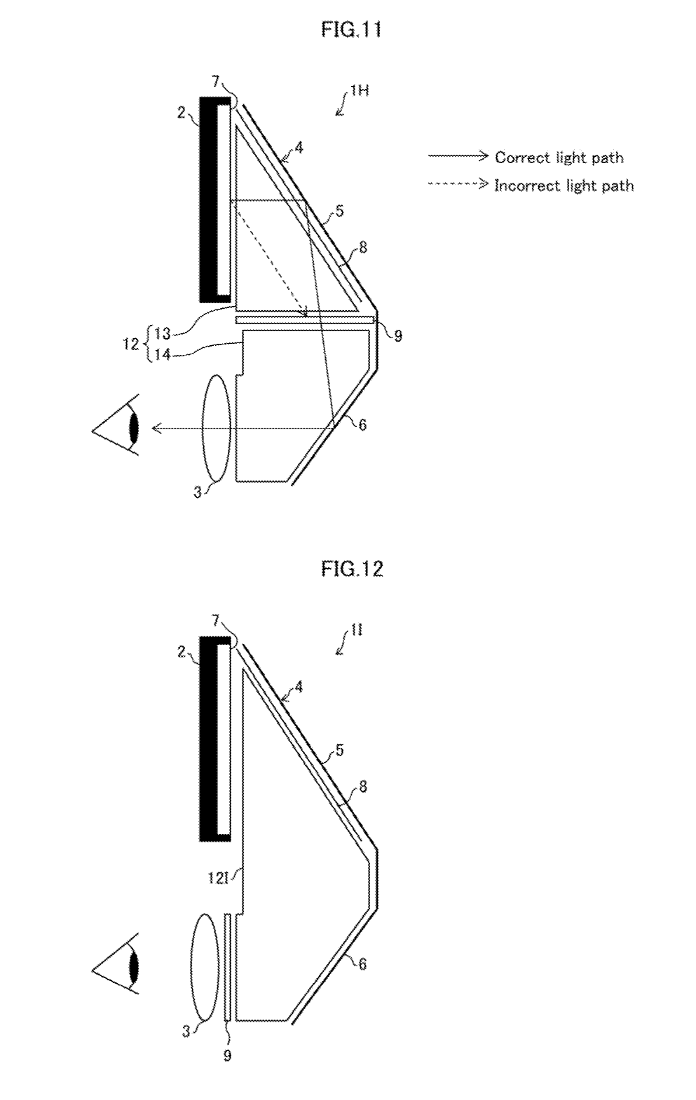

FIG. 12 is a schematic diagram of a head-mounted display 1I, which is another head-mounted display in accordance with Embodiment 7. The head-mounted display 1H described above with reference to FIG. 11 is configured such that the polarizing plate 9 is disposed between the first refracting section 13 and the second refracting section 14 of the transparent refractive member 12. However, the present invention is not limited to such a configuration.

Alternatively, an integral transparent refractive member 121 may be constructed as an integral member, and the polarizing plate 9 may be disposed between the eyepiece lens 3 and the transparent refractive member 121. Further alternatively, the polarizing plate 9 may be disposed on an opposite side of the eyepiece lens 3 from the transparent refractive member 121.

Furthermore, the Fresnel structure 11 described above with reference to FIG. 10 may be provided on the second mirror 6. Alternatively, the second quarter wave plate 8 may be provided on the second mirror 6, as described above with reference to FIG. 7.

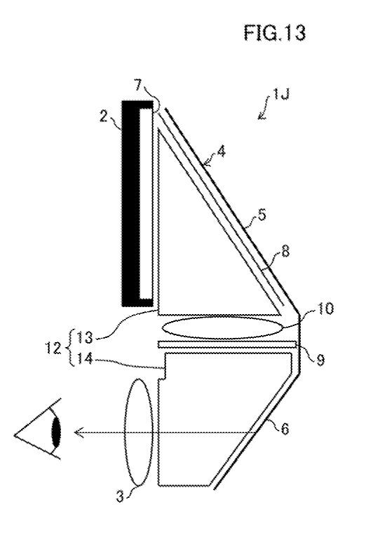

FIG. 13 is a schematic diagram of a head-mounted display 1J, which is still another head-mounted display in accordance with Embodiment 7. In the head-mounted display 1J, the aberration lens 10 is disposed between the polarizing plate 9 and the first refracting section 13. The aberration lens 10 may be bonded to the first refracting section 13. It is possible to have bonding with both blocks if a low index glue and a Fresnel structure are used, or if aberration lens 10 has a significantly different refractive index to the block. The polarizing plate 9 may be disposed between the first refracting section 13 and the second refracting section 14. Alternatively, the polarizing plate 9 may be disposed on a surface of the first mirror 5 or on a surface of the second mirror 6 or may be provided on the eyepiece lens 3. The polarizing plate 9 may be provided, together with the quarter wave plate 8, on either the first mirror 5 or the second mirror 6 or on both the first mirror 5 and the second mirror 6.

[Recap]

Head-mounted displays 1 and 1A to 1J in accordance with a first aspect of the present invention each include: a display unit (liquid crystal display unit 2, display unit 2E) including a display surface 7 and configured to display an image on the display surface 7; an eyepiece lens 3, when the display unit (liquid crystal display unit 2, display unit 2E) is viewed in a direction of a normal to the display surface 7 of the display unit (liquid crystal display unit 2, display unit 2E), disposed at a position lower or higher than the display unit (liquid crystal display unit 2, display unit 2E) without overlapping the display unit (liquid crystal display unit 2, display unit 2E); and a mirror unit 4 configured to reflect light based on the image displayed on the display surface 7 and guide the light thus reflected to the eyepiece lens 3.

According to the above arrangement, light based on an image displayed on the display surface of a display unit is reflected by a mirror unit, and the light thus reflected is guided to the eyepiece lens which is disposed at a position lower or higher than the display unit. This makes it possible to provide a head-mounted display with improved compactness while holding the display unit and the eyepiece lens.

In a second aspect of the present invention, the head-mounted displays 1 and 1A to 1J can be arranged such that, in the first aspect of the present invention, the mirror unit 4 includes: a first mirror 5 configured to reflect the light based on the image; and a second mirror 6 configured to reflect, toward the eyepiece lens 3, the light reflected by the first mirror 5, and the first mirror 5 and the second mirror 6 are disposed in a V-shaped arrangement.

According to the above arrangement, a first mirror and a second mirror (6) are disposed in a V-shaped arrangement.

This further improves compactness of the head-mounted display.

In a third aspect of the present invention, the head-mounted displays 1A to 1D and 1F to 1J can be arranged such that, in the second aspect of the present invention, the display unit is a liquid crystal display unit 2, and each of the head-mounted displays 1A to 1D and 1F to 1J further includes: a quarter wave plate 8 disposed on a surface of the first mirror 5; and a polarizing plate 9 configured to transmit light passing through the quarter wave plate 8 and reflected by the first mirror 5, while preventing transmission of direct light from the display surface 7.

According to the above arrangement, it is possible to prevent stray light from entering the eyepiece lens.

In a forth aspect of the present invention, the head-mounted displays 1A to 1D and 1F to 1J can be arranged such that, in the third aspect of the present invention, the polarizing plate 9 is disposed between the first mirror 5 and the second mirror 6, on a surface of the second mirror 6, or on the eyepiece lens 3.

According to the above arrangement, it is possible to prevent stray light from entering the eyepiece lens.

In a fifth aspect of the present invention, the head-mounted display 1D can be arranged such that, in the second aspect of the present invention, the display unit is a liquid crystal display unit 2, the head-mounted display 1D further includes: a first quarter wave plate (quarter wave plate 8) disposed on a surface of the first mirror 5; a second quarter wave plate (quarter wave plate 8) disposed on a surface of the second mirror 6; and a polarizing plate 9 disposed on the eyepiece lens 3 so as to transmit light passing through the second quarter wave plate (quarter wave plate 8) and then reflected by the second mirror 6, while preventing transmission of light emitted from the display surface 7, directly entering the second mirror 6, and then reflected by the second mirror 6.

According to the above arrangement, disposing two quarter wave plates minimizes scattering of light emitted from the display surface and then reflected by the first mirror and the second mirror toward the eyepiece lens.

In a sixth aspect of the present invention, the head-mounted display 1E can be arranged such that, in the second aspect of the present invention, the head-mounted display 1E further includes: a first polarizing plate (polarizing plate 9) disposed on the display surface 7 of the display unit 2E; a quarter wave plate 8 disposed on a surface of the first mirror 5; and a second polarizing plate (polarizing plate 9) configured to transmit light passing through the quarter wave plate 8 and then reflected by the first mirror 5, while preventing transmission of light emitted from the display surface 7, passing through the first polarizing plate (polarizing plate 9), and then entering the second polarizing plate.

According to the above arrangement, the present invention can be applied to a display unit of any type which is different from a liquid crystal display unit, such as a display unit including, for example, an organic light emitting diode (OLED).

In a seventh aspect of the present invention, the head-mounted display 1F can be arranged such that, in the second aspect of the present invention, the head-mounted display 1F further includes an aberration lens 10 disposed between the first mirror 5 and the second mirror 6.

According to the above arrangement, providing an aberration lens minimizes aberrations of an image viewed through the eyepiece lens and thus reduces image aberrations.

In an eighth aspect of the present invention, the head-mounted display 1G can be arranged such that, in the third aspect of the present invention, a Fresnel structure 11 is formed on a surface of the second mirror 6.

The above arrangement improves the field of view of the head-mounted display.

In a ninth aspect of the present invention, the head-mounted displays 1H, 1I, and 1J can be arranged such that, in the third aspect of the present invention, each of the head-mounted displays 1H, 1I, and 1J further includes a transparent refractive member 12 configured to transmit light emitted from the display surface 7 and then reflected by the first mirror 5 and the second mirror 6 toward the eyepiece lens 3.

The above arrangement improves the field of view of the head-mounted display and reduces ghost images viewed through the eyepiece lens.

In a tenth aspect of the present invention, the head-mounted displays 1H and 1J can be arranged such that, in the ninth aspect of the present invention, the polarizing plate 9 is disposed between the first mirror 5 and the second mirror 6, and the transparent refractive member 12 includes: a first refracting section 13 disposed between the first mirror 5 and the polarizing plate 9; and a second refracting section 14 disposed between the second mirror 6 and the polarizing plate 9.

According to the above arrangement, a polarizing plate disposed between the first mirror and the second mirror prevents stray light from entering the eyepiece lens.

In an eleventh aspect of the present invention, the head-mounted display 1J can be arranged such that, in the tenth aspect of the present invention, the head-mounted display 1J further includes an aberration lens 10 disposed between the first refracting section 13 and the second refracting section 14.

According to the above arrangement, providing an aberration lens minimizes aberrations of an image viewed through the eyepiece lens and thus reduces image aberrations.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Head-mounted display
2: Liquid crystal display unit (display unit)
3: Eyepiece lens
4: Mirror unit
5: First mirror (mirror unit)
6: Second mirror (mirror unit)
7: Display surface
8: Quarter wave plate (first quarter wave plate, second quarter wave plate)
9: Polarizing plate (first polarizing plate, second polarizing plate)
10: Aberration lens
11: Fresnel structure
12: Transparent refractive member
13: First refracting section
14: Second refracting section

1. A head-mounted display comprising:
a display unit including a display surface and configured to display an image on the display surface;
an eyepiece lens, when the display unit is viewed in a direction of a normal to the display surface of the display unit, disposed at a position lower or higher than the display unit without overlapping the display unit; and
a mirror unit configured to reflect light based on the image displayed on the display surface and guide the light thus reflected to the eyepiece lens.

2. The head-mounted display according to claim 1, wherein
the mirror unit includes: a first mirror configured to reflect the light based on the image; and a second mirror configured to reflect, toward the eyepiece lens, the light reflected by the first mirror, and
the first mirror and the second mirror are disposed in a V-shaped arrangement.

3. The head-mounted display according to claim 2, wherein
the display unit is a liquid crystal display unit, and
the head-mounted display further includes: a quarter wave plate disposed on a surface of the first mirror; and a polarizing plate configured to transmit light passing through the quarter wave plate and reflected by the first mirror, while preventing transmission of direct light from the display surface.

4. The head-mounted display according to claim 3, wherein
the polarizing plate is disposed between the first mirror and the second mirror, on a surface of the second mirror, or on the eyepiece lens.

5. The head-mounted display according to claim 2, wherein
the display unit is a liquid crystal display unit,
the head-mounted display further includes: a first quarter wave plate disposed on a surface of the first mirror; a second quarter wave plate disposed on a surface of the second mirror; and a polarizing plate disposed on the eyepiece lens so as to transmit light passing through the second quarter wave plate and then reflected by the second mirror, while preventing transmission of light emitted from the display surface, directly entering the second mirror, and then reflected by the second mirror.

6. The head-mounted display according to claim 2, further comprising:
a first polarizing plate disposed on the display surface of the display unit;
a quarter wave plate disposed on a surface of the first mirror; and
a second polarizing plate configured to transmit light passing through the quarter wave plate and then reflected by the first mirror, while preventing transmission of light emitted from the display surface, passing through the first polarizing plate, and then entering the second polarizing plate.

7. The head-mounted display according to claim 2, further comprising:
an aberration lens disposed between the first mirror and the second mirror.

8. The head-mounted display according to claim 3, wherein
a Fresnel structure is formed on a surface of the second mirror.

9. The head-mounted display according to claim 3, further comprising:
a transparent refractive member configured to transmit light emitted from the display surface and then reflected by the first mirror and the second mirror toward the eyepiece lens.

10. The head-mounted display according to claim 9, wherein
the polarizing plate is disposed between the first mirror and the second mirror, and
the transparent refractive member includes: a first refracting section disposed between the first mirror and the polarizing plate; and a second refracting section disposed between the second mirror and the polarizing plate.

11. The head-mounted display according to claim 10, further comprising:
an aberration lens disposed between the first refracting section and the second refracting section.
